(19) United States
(12) Patent Application Publication
(10) Pub. No.: US 2011/0027711 A1
(43) Pub. Date: Feb. 3, 2011

(54) TONER FOR ELECTROPHOTOGRAPHY, DEVELOPER AND IMAGE FORMING APPARATUS

(75) Inventor: Keiichi Tanida, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/840,323

(22) Filed: Jul. 21, 2010

(30) Foreign Application Priority Data
Jul. 30, 2009 (JP) 2009-178105

(51) Int. Cl. G03G 9/00; G03G 15/08

(52) U.S. Cl. 430/105; 430/108.4; 399/252

(57) ABSTRACT

Toner for electrophotography contains toner base particles containing a binder resin and a colorant, and an external additive to be externally added to the toner base particles, and the external additive includes surface treated particles obtained by surface treating resin fine particles with a fatty acid metal salt.

### BACKGROUND OF THE INVENTION

1. Field of the Invention

The present invention relates to toner for Electrophotography, developer containing the toner for Electrophotography and an image forming apparatus using the developer.

2. Description of the Related Art

An electrophotographic image forming apparatus such as a copier, a printer, a facsimile machine or a complex machine of these includes an image bearing member, a charger for uniformly charging a surface of the image bearing member, an exposure device for forming an electrostatic latent image on the image bearing member, a developing device for developing an electrostatic latent image on the image bearing member into a toner image, a transfer device for transferring a toner image on the image bearing member to a sheet, etc. The image forming apparatus forms a desired image on a sheet by transferring a toner image onto the sheet as described above using the above respective devices.

There have been used image forming apparatuses of this type provided with a color printing function for forming not only a black-and-white image, but also a color image on a sheet. Specifically, image forming apparatuses such as one-drum type color copiers and color complex machines (color MFP) including one photoconductive drum are being used. However, in such a one-drum type image forming apparatus, when one sheet is to be color printed, a photoconductive drum as an image bearing member needs to be rotated every time a toner image of any one of colors such as black, yellow, cyan and magenta is developed for the sheet. Thus, there has been a problem that a printing speed at the time of color printing is reduced to about ¼ as compared with the one at the time of black-and-white printing. In other words, color printing has had a problem of requiring about four times as much time as black-and-white printing. Accordingly, image forming apparatuses provided with the color printing function have been required to shorten a printing time, i.e. to speed up printing. Tandem color image forming apparatuses and the like can be cited as those for satisfying such a requirement.

Specifically, a tandem color image forming apparatus includes, for example, an intermediate transfer belt for, after toner images electrophotographically formed on separate image bearing members corresponding to the respective colors are primarily transferred thereto, secondarily transferring the toner images to a transfer material such as a sheet, and forms a full color image by superimposing toner images of a plurality of colors such as yellow (Y), magenta (M), cyan (C) and black (K) on the intermediate transfer belt. In such a color image forming apparatus, image forming units corresponding to the respective colors are arranged side by side along the intermediate transfer belt to superimpose the toner images of the plurality of colors. Toner images of the four colors of YMCK formed on the respective photoconductive drums of the image forming units are successively so transferred (primary transfer) to the intermediate transfer belt as to be superimposed one on another to form a full color image. The color image formed on this intermediate transfer belt is transferred (secondary transfer) to a transfer material such as a sheet by a secondary transfer roller disposed to face the intermediate transfer belt. In this way, the toner images corresponding to the respective colors are formed on the image bearing members of the image forming units corresponding to the respective colors and superimposed one on another to form the full color image, whereby the tandem image forming apparatus realizes high-speed printing.

On the other hand, color printing has a tendency that the coverage rates of the single color largely vary as compared with black-and-white printing since one image is formed using, for example, toner of four colors. If the coverage rate of the toner of a specific color continues to be poor, it means that the toner not used very much for a long time is present although images are being formed.

Electrophotographic images are known to have such a tendency that fogging and the like are likely to occur and it becomes difficult to form good images if the image forming operation is performed for a long time. Particularly, in a color image forming apparatus whose coverage rate largely varies depending on images to be formed, if the image forming operation is performed for a long time, the tendency that fogging is likely to occur and it becomes difficult to form good images becomes stronger, for example, when high-density printing is performed after low-density printing was repeatedly performed for a long time.

In order to suppress the occurrence of fogging as described above, studies are being conducted, for example, on the following toner.

First of all, as a first example, study is being made on toner which is composed of colored resin fine particles (toner base particles) and an external additive, wherein the external additive contains inorganic fine powder treated with a fatty acid and/or a fatty acid metal salt.

As a second example, study is being made on magnetic toner for electrophotography which is composed of toner particles (toner base particles) containing at least a binder resin and magnetic powder and an additive (external additive), wherein the additive contains ultrafine titanium oxide particles hydrophobized by being surface treated with fatty acid aluminum and hydrophobized silica and the ultrafine titanium oxide particles has a specific surface area of 80 to 120 m²/g, a hydrophobic degree of 50 to 80 weight % and an alumina content of 0.4 to 1.1 weight %.

### SUMMARY OF THE INVENTION

An object of the present invention is to provide toner for electrophotography capable of forming high-quality images for a long period of time. Another object of the present invention is to provide developer containing the toner for electrophotography and an image forming apparatus using the developer.

In order to accomplish this object, one aspect of the present invention is directed to toner for electrophotography, comprising toner base particles containing a binder resin and a colorant; and an external additive to be externally added to the toner base particles, wherein the external additive contains surface treated particles obtained by surface treating resin fine particles with a fatty acid metal salt.

Another aspect of the present invention is directed to developer, comprising the above toner for electrophotography; and a carrier.

Still another aspect of the present invention is directed to an image forming apparatus, comprising a plurality of image bearing members arranged side by side in a specified direction to form toner images formed by toner of different colors on the respective surfaces thereof; and a plurality of developing rollers arranged to face the corresponding image bearing members and adapted to convey the toner of developer while bearing them on the surfaces thereof and supply the conveyed toner to the surfaces of the corresponding image bearing members; wherein the respective image bearing members are amorphous silicon photoconductors, and each developer is the one containing the above toner for electrophotography and a carrier.

### BRIEF DESCRIPTION OF THE DRAWING

FIG. 1 is a schematic sectional view showing the entire construction of an image forming apparatus used in one embodiment.

### DETAILED DESCRIPTION OF THE PREFERRED EMBODIMENTS

According to studies conducted by the present inventors, toner containing inorganic fine particles treated with a fatty acid or its metal salt as an external additive may not be able to. sufficiently fulfill a function of the inorganic fine particles to improve abradability and flowability and it has been difficult to obtain high-quality images for a long period of time. Particularly, in an image forming apparatus including an amorphous silicon photoconductor as a photoconductive drum, so-called filming in which impurities such as toner and the like not involved in image formation adhere to the surface of the photoconductive drum might possibly occur due to a reduction in abradability for the photoconductive drum.

Before arriving at the present invention, the present inventors paid attention to the presence of such toner not used very much for a long time as described above if low-density printing was repeatedly performed for a long time. The present inventors inferred the reason why fogging was likely to occur if high-density printing was performed after low-density printing was repeatedly performed for a long time as follows.

Developer not used for a long time despite the fact that an image forming apparatus has been driven as described above is stressed and toner contained in the developer comes to have a reduced performance, for example, by losing specific electric charge. If high-density printing with a high coverage rate is performed in this state, the toner is supplied thereafter. Then, there is a difference in charged amount between the toner with the reduced performance and the newly supplied toner and electric charge move between the toner. Then, the toner with the reduced performance loses more electric charge, more deviating from the charged amount suitable for image development, with the result that the developer comes to have a higher ratio of toner particles with negative polarity. Thus, if high-density printing is performed after low-density printing was performed for a long time, a ratio of the negatively charged toner particles in the developer increases, wherefore the toner moves to a part other than an exposed part (image part) without moving to the exposed part (image part), which results in toner adhesion to a non-exposed part (non-image part: blank part), i.e. the occurrence of so-called fogging.

On the other hand, in order to suppress the occurrence of the above fogging, it is thought to newly supply the toner after the toner with the reduced performance is removed from the image forming apparatus. Specifically, it is thought to adopt a method for forcibly transferring the toner with the reduced performance to an image bearing member before the new toner is supplied and removing the toner with the reduced performance from the image forming apparatus, for example, using cleaners such as a drum cleaner for removing the toner residual on the image bearing member after a toner image on the image bearing member is transferred to a sheet from the image bearing member and a belt cleaner for removing the toner residual on an intermediate transfer belt after the second transfer.

However, the above method is thought to be not preferable since the toner is consumed even when no images are formed.

The present invention was developed in view of the above situation and aims to provide toner for electrophotography capable of suppressing the occurrence of fogging and, hence, forming high-quality images for a long period of time even if high-density images are printed after low-density printing was performed for a long time. The present invention also aims to provide developer containing the toner for electrophotography and an image forming apparatus using the developer.

Embodiments are described below. The present invention is not limited to these.

### [Toner]

Toner for electrophotography (hereinafter, merely referred to as “toner” in some cases) contains toner base particles containing a binder resin and a colorant and an external additive to be externally added to the toner base particles, wherein the external additive contains surface treated particles obtained by surface treating resin fine particles with a fatty acid metal salt.

Such toner for electrophotography can suppress the occurrence of fogging and, hence, form high-quality images for a long period of time even if high-density images are printed after low-density printing was performed for a long time.

This is thought to be because the toner has a little change in charged amount even if low-density printing with a low coverage rate is performed for a long time. Specifically, the following reason can be thought.

Resin fine particles such as acrylic resin fine particles and methacrylic resin fine particles are positively charged. Surface treated particles obtained by surface treating the resin fine particles with a fatty acid metal salt are negatively charged. The reason why the surface treated particles are negatively charged is thought to be that the fatty acid metal salt coating the surfaces of the resin fine particles is negatively charged. Thus, such surface treated particles are negatively charged in an initial state, but the fatty acid metal salt gradually separates from the surface treated particles and a positive electrification property is exhibited on the such surface treated particles when the developer is mixed and agitated to be stressed such as when low-density printing is performed. Thus, the surface treated particles are thought to contribute to the toner being gradually positively charged when low-density printing is performed.

On the other hand, the respective components of the toner base particles other than the surface treated particles, particularly most of the external additive other than the surface treated particles is thought to be gradually negatively charged as the developer is mixed and agitated. Thus, the toner base particles not being externally added the surface treated particles are thought to be gradually negatively charged by performing low-density printing.

Accordingly, a change in the charged amount of the toner containing the surface treated particles is thought to be buffered as described above even if low-density printing is performed. Thus, the toner having the above composition is thought to have a little change in the charged amount even if high-density printing with a high coverage rate is performed after low-density printing with a low coverage rate was performed for a long time.

Since the above toner has a little change in the charged amount, it is though to be able to suppress the occurrence of fogging and, hence, form high-quality images for a long period of time.

### <Toner Base Particles>

The toner base particle is not particularly limited provided that they contain the binder resin and the colorant and are of the form usable as such. It is preferable that the toner base particles are preferably spherical and the particle diameters thereof are 3 to 9 μm in volume average diameter. The volume average diameter here can be measured, for example, through a measurement by a laser diffraction scattering method or a measurement using a general particle size analyzer.

### (Binder Resin)

Any binder resin can be used without any particularly limitation provided that it has been conventionally used as the binder resin of toner base particle. Specifically, styrene resins, acrylic resins, styrene-acrylic copolymers, polyethylene resins, polypropylene resins, vinyl chloride resins, polyester resins, polyamide resins, polyurethane resins, polyvinyl alcohol resins, vinyl ether resins, N-vinyl resins and styrene-butadiene resins can be, for example, cited as the binder resin. Among these, polyester resins are preferably used in terms of good low-temperature fixing property and a wide non-offset temperature range. The above respective binder resins may be singly used or two or more of them may be used in combination.

The polyester resins may be, for example, those obtained by condensation, polymerization or co-condensation polymerization of an alcohol component and a carboxylic acid component. The following components can be cited as components used upon synthesizing polyester resins.

The alcohol component is not particularly limited provided that it can be used as an alcohol for synthesizing a polyester resin. The alcohol component needs to contain an alcohol having two or more hydroxyl groups in a molecule (dihydric or higher polyhydroric alcohol). Out of those used as the alcohol component, diols such as ethylene glycol, diethylene glycol, triethylene glycol, 1,2-propylene glycol, 1,3-propylene glycol, 1,4-butandiol, neopentyl glycol, 1,4-butenediol, 1,5-pentandiol, 1,6-hexandiol, 1,4-cyclohexanedimethanol, dipropylene glycol, polyethylene glycol, polyproplylene glycol, and polytetramethylene glycol; and bisphenols such as bisphenol A, hydrogenated bisphenol, polyoxyethylenated bisphenol A and polyoxypropylenated bisphenol A can be, for example, specifically cited as dihydric alcohols. Out of those used as the alcohol component, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetiol, trimethylolethane, trimethylolpropane and 1,3,5-trihydroxymethylbenene can be, for example, specifically cited as trihydric or higher polyhydric alcohols. Out of these, bisphenols are more preferable in terms of good dispersibility of the components of the toner base particles such as colorant and wax, other than binder resin, in the toner base particles, heat resistance storage stability, low-temperature fixing property and charge storage stability. The above respective alcohol components may be singly used or two or more of them may be used in combination.

The carboxylic acid component is not particularly limited provided it is usable as the one for synthesizing a polyester resin. The carboxylic acid component is not only a carboxylic acid, but may also be acid anhydrate, lower alkyl ester or the like of a carboxylic acid. The carboxylic acid component needs to contain a carboxylic acid (dicarboxylic or higher polycarboxylic acid) having two or more hydroxyl groups in a molecule. Out of those used as the carboxylic acid, maleic acids, fumaric acids, citraconic acids, itaconic acids, glutaconic acids, phthalic acids, isophthalic acids, terephthalic acids, cyclohexane dicarboxylic acids, succinic acids, adipic acids, sebacic acids, azelaic acids, malonic acids, alkyl succinic acids and alkenyl succinic acids can be specifically, for example, cited as dicarboxylic acids. N-butyl succinic acid, n-octyl succinic acid, n-dodecyl succinic acid and isododecyl succinic acid can be, for example, cited as alkyl succinic acids. N-butenyl succinic acid, isobutyl succinic acid, isobutenyl succinic acid, n-octenyl succinic acid, n-dodecenyl succinic acid and isododecenyl succinic acid can be, for example, cited as alkenyl succinic acids. Out of these used as the carboxylic acid, 1,2,4-benzenetricarboxylic acid (trimellitic acid), 1,2,5-benzenetricarboxylic acid, 2,5,7-naphthalene-tricarboxylic acid, 1,2,4-naphthalene tricarboxylic acid, 1,2,4-butane tricarboxylic acid, 1,2,5-hexanetricarboxylic acid, 1, 3-dicaroxyl-2-methyl-2-methylenecarboxypropane, 1,2,4-cyclohexane tricarboxylic acid, tetra(methylene carboxyl)methane, 1,2,7,8-octane tetracarboxylic acid, pyromellitic acid and EMPOL trimeric acid can be specifically, for example, cited as tricarboxylic or higher polycarboxylic acids. Out of these, fumaric acids are preferable in terms of good charge storage stability and environmental stability. The above carboxylic acids may be singly used or two or more of them may be used in combination.

Thermoplastic resins as described are preferably used as the binder resin in terms of the fixing property, but the binder resin needs not be composed of only a thermoplastic resin and a cross-linking agent and a thermosetting resin may be used in combination with the thermoplastic resin. By introducing a partial cross-linking structure into the binder resin in this way, it is possible to improve the storage stability, form retaining property, durability and the like of the toner while suppressing a reduction in the fixing property.

### (Colorant)

Known pigments and dyes can be used as the colorant to give a desired color to the toner. Specifically, the following colorants can be, for example, cited depending on the color. Carbon blacks such as acetylene black, run black and aniline black can be, for example, cited as black pigments. Chrome yellow, zinc yellow, cadmium yellow, yellow iron oxide, mineral fast yellow, nickel titanium yellow, navels yellow, naphtol yellow S, Hansa yellow G, Hansa yellow 10G, benzene yellow G, benzene yellow GR, quinoline yellow lake, permanent yellow NCG, tartrazine lake and C. I. pigment yellow 180 can be, for example, cited as yellow pigments. Reddish chrome yellow, molybdenum orange, permanent orange GTR, pyrazolone orange, Vulcan orange and indanthrene brilliant orange RK can be, for example, cited as orange pigments. Colcothar, cadmium red, red lead, cadmium mercury sulfide, permanent red 4R, lithol red, pyrazolone red, watching red calcium salt, lake red D, brilliant carmine 6B, eosin lake, rhodamine lake, alizarin lake, brilliant carmine 3B and C. I. pigment red 238 can be, for example, cited as red pigments. Manganese violet, fast violet B and methyl violet lake can be, for example, cited as violet pigments. Dark blue, cobalt blue, alkali blue lake, Victoria blue lake, phthalocyanine blue, metal-free phthalocyanine blue, phthalocyanine blue-partial chlorination product, fast sky blue, indanthrene blue-BC and C. I. pigment blue-15-3 can be, for example, cited as blue pigments. Chrome green, chrome oxide, pigment green B, malachite green and fanal yellow green can be, for example, cited as green pigments. Chinese white, titanium oxide, antimony white, zinc sulfide, baryte powder, barium carbonate, clay, silica, white carbon, talc and alumina white can be, for example, cited as white pigments.

In order to achieve a preferable image density, the added amount of the colorant is generally 1 to 10 parts by mass, preferably 2 to 5 parts by mass, per 100 parts by mass of the binder resin.

### (Charge-Controlling Agent)

The toner base particles generally contain a charge-controlling agent to improve an electrification property and the like. The charge-controlling agent is used without any particular limitation provided that it has been conventionally used as the charge-controlling agent of toner base particles. Its specific examples include charge-controlling agent with a positive electrification property such as nigrosine, quaternary ammonium salt compounds and resin type charge-controlling agents in which an amine compound is combined with resin. Out of these, quaternary ammonium salt compounds are preferable in terms of good charge storage stability and a quick charge rising property. The added amount of the charge-controlling agent is preferably 0.5 to 10 parts by mass, more preferably 1 to 5 parts by mass per 100 parts by mass of the binder resin. If the added amount of the charge-controlling agent is too small, it becomes difficult to stably charge the toner to have a specified polarity and fogging tends to occur more easily. If the added amount of the charge-controlling agent is too large, an image failure is likely to occur due to environmental resistance, particularly an electrification failure under high temperature and high humidity and defects such as the contamination of the photoconductor are likely to occur.

### (Wax)

The toner base particles generally contain wax to improve the fixing property and offset property. The wax is used without any particular limitation provided that it has conventionally been used as the wax of toner base particles. Its specific examples include plant waxes such as Carnauba wax, sugar cane wax and wood wax; animal waxes such as honey wax, insect wax, whale wax and wool wax; and synthetic hydrocarbon waxes such as Fischer-Tropsch (hereinafter, also referred to as “FT”) wax, polyethylene wax and polypropylene wax. Out of these, synthetic hydrocarbon waxes such as FT wax and polyethylene wax are preferable and FT was is more preferable in terms of good dispersibility in the binder resin. The added amount of the wax is preferably 0.1 to 20 parts by mass per 100 parts by mass of the binder resin. If the added amount is too small, there is a tendency that effects by the addition of the wax cannot be sufficiently obtained. If the added amount is too large, blocking resistance decreases and the wax may separate from the toner.

### (Production Method)

A production method for the toner base particles is not particularly limited. The toner base particles can be, for example, produced as follows.

The above respective components of the toner base particles such as the binder resin and the colorant are mixed by a mixer or the like. The mixer can be a known one and is, for example, a Henschel type mixer such as a Henschel mixer, a super mixer or a Mechanomill®, an Ongumill®, a hybridization system or a Cosmosystem®.

Subsequently, the obtained mixture is melted and kneaded by a kneading machine. The kneading machine can be a known one and is, for example, a twin-screw extruder, a triple roll mill, or a laboblast mill. The twin-screw extruder is preferably used. A temperature at the time of melting and kneading is preferably equal to or above the softening temperature of the binder resin and below the decomposition temperature of the binder resin.

Subsequently, the obtained melted and kneaded material is cooled to obtain a solid material, which is crushed by a crusher or the like. The crusher can be a known one and is, for example, an air flow crusher such as a jet crusher for crushing using an ultrasonic jet stream or an impact crusher. The air flow crusher is preferably used.

Finally, the obtained crushed material is classified by a classifier or the like. By the classification, excessively crushed particles and roughly crushed particles can be removed, whereby desired toner base particles can be obtained. The classifier can be a known one and is, for example, a wind power classifier such as a rotary wind power classifier or a centrifugal classifier. The wind power classifier is preferably used.

### <External Additive>

The external additive contains surface treated particles obtained by surface treating resin fine particles with a fatty acid metal salt. The external additive generally contains another external additive such as inorganic fine particles in addition to the surface treated particles in order to improve abradability and flowability.

The surface treated particles are not particularly limited provided that they are obtained by surface treating resin fine particles with a fatty acid metal salt. Specifically, the surface treated particles are, for example, those obtained by mixing resin fine particles and a fatty acid metal salt.

The resin fine particles are not particularly limited provided that they can be used as an external additive for the toner. Specifically, acrylic resin fine particles mainly containing an acrylic resin, methacrylic resin fine particles mainly containing a methacrylic resin, and fluororesin can be, for example, cited as the resin fine particles. Out of these, acrylic resin fine particles and methacrylic resin fine particles are preferable in terms of the electrification property. By using acrylic resin fine particles and methacrylic resin fine particles as the resin fine particles, toner can be obtained which can suppress the occurrence of fogging more even if high-density printing is performed after low-density printing was performed for a long time. This is thought to be because the charged amount of the toner is suitably adjusted when the fatty acid metal salt gradually separates from the surface treated particles since the positive electrification property of the resin fine particles is preferable. The above resin fine particles may be singly used or two or more of them may be used in combination.

The resin fine particles are preferably spherical and the particle diameters thereof are preferably 30 to 500 nm in volume average diameter. The volume average diameter here can be measured, for example, through a measurement by a laser diffraction scattering method or a measurement using a general particle size analyzer.

The fatty acid constituting the fatty acid metal salt is not particularly limited, but is preferably a saturated fatty acid having a carbon number of 12 to 24. If the carbon number is too small, it may be possibly difficult to use the fatty acid since it is not solid at room temperature. If the carbon number is too large, it becomes difficult to adjust the electrification property of the surface treated particles and there is a possibility that the fogging suppressing effect is not sufficiently achieved. Thus, by using a saturated fatty acid having a carbon number of 12 to 24 as the fatty acid metal salt, toner can be obtained which can suppress the occurrence of fogging more even if high-density printing is performed after low-density printing was performed for a long time. This is thought to be because the surface treated particles can be obtained which can better achieve an effect of suppressing a change in the charged amount of the toner.

The fatty acid may be a straight chain fatty acid or a branched fatty acid, but the straight chain fatty acid is preferable. Specifically, a stearic acid, a lauric acid, a ricinoleic acid, an octylic acid and an arachidic acid can be, for example, cited as such. Out of these, the stearic acid and the lauric acid are preferable in terms of good adhesion to the surfaces of the resin fine particles. The above fatty acids may be singly used or two or more of them may be used in combination.

The metal of the fatty acid metal salt is not particularly limited provided that it is a metal capable of forming a salt together with a fatty acid. Specifically, zinc, magnesium, calcium and lithium can be, for example, cited as such. Out of these, zinc and magnesium are preferable in terms of good electrification property. The above metals may be singly used or two or more of them may be used in combination.

Thus, zinc stearate, magnesium stearate, zinc laurate, magnesium laurate and calcium stearate can be, for example, cited as the fatty acid metal salt. Out of these, zinc stearate, magnesium stearate and zinc laurate are preferable in terms of good charge storage stability. The above respective fatty acid metal salts may be singly used or two or more of them may be used in combination.

The added amount of the fatty acid metal salt is preferably 0.01 to 0.1 part by mass per 1 part by mass of the resin fine particles. If the added amount of the fatty acid metal salt is too small, an initial electrification property of the toner may possibly be too high. If the added amount of the fatty acid metal salt is too large, there is a tendency that a negative electrification property is too strong and the fogging preventing effect decreases. From this, if the content is in the above range, the occurrence of fogging can be suppressed more even if high-density printing is performed after low-density printing was performed for a long time. Thus, high-quality images can be formed for a longer period of time. This is thought to be because the surface treated particles obtained with such an added amount are effective in suppressing an initial charged amount increase of the toner and has an effect of preventing the creation of the oppositely charged toner when the toner is stressed due to repeated low-density printing.

Inorganic fine particles and the like can be cited as the external additive other than the surface treated particles as described above. Silica particles, titanium oxide particles, alumina particles, magnetite particles and the like can be cited as the inorganic fine particles. Silica particles and titanium oxide particles are preferable in terms of good flowability, electrification property and abradability. The above inorganic fine particles may be singly used or two or more of kinds of them may be used in combination.

to 1 part by mass of the surface treated particles are preferably contained per 100 parts by mass of the toner base particles. If the content of the surface treated particles in the toner base particles is too small, there is a possibility that the effect of increasing the charged amount is weak and fogging is likely to occur. If the content of the surface treated particles in the toner base particles is too large, there is a possibility that the influence of an electrification variation of the surface treated particles before and after the toner is stressed through agitation or the like on the charged amount of the entire toner becomes too large, the charged amount conversely becomes unstable and fogging is likely to occur. Thus, if the content is in the above range, the occurrence of fogging can be suppressed more even if high-density printing is performed after low-density printing was performed for a long time. Thus, high-quality images can be formed for a longer period of time. This is thought to be because the effect of the surface treated particles to suppress a change in the charged amount of the toner can be achieved more.

It is preferable that the external additive preferably contains inorganic fine particles and that 0.25 to 30 parts by mass of the surface treated particles are contained per 100 parts by mass of the external additive. If the content of the surface treated particles per the total amount of the external additive is too small, there is a possibility that the effect of improving the electrification property is weak and fogging is likely to occur. If the content of the surface treated particles per the total amount of the external additive is too large, there is a possibility that the influence of an electrification variation of the surface treated particles before and after the toner is stressed through agitation or the like on the charged amount of the entire toner becomes too large, the charged amount conversely becomes unstable and fogging is likely to occur. Thus, if the content is in the above range, the occurrence of fogging can be suppressed more even if high-density printing is performed after low-density printing was performed for a long time. Thus, high-quality images can be formed for a longer period of time. This is thought to be because the effect of the surface treated particles to suppress a change in the charged amount of the toner can be achieved more even if the inorganic fine particles come to be negatively charged as low-density printing is performed.

The obtained toner is preferably used in an image forming apparatus including an amorphous silicon photoconductor as described later. If toner containing an external additive obtained by surface treating inorganic fine particles is, for example, used in such an image forming apparatus, there is a tendency that abradability is generally insufficient and filming is likely to occur. By using the above toner, it is possible to suppress fogging while sufficiently exhibiting abradability even in such an image forming apparatus. Thus, high-quality images can be formed for a long period of time. This is thought to be because a surface treatment or the like is not applied to the inorganic fine particles of the toner as described above.

### [Developer]

The developer containing the above toner may be a one-component developer containing the toner, but no carrier or may be a two-component developer containing the toner and carrier. The two-component developer is preferably used. Here, the two-component developer is described. The developer according to this embodiment contains the toner for electrophotography and carrier.

### (Carrier)

The carrier is not particularly limited provided that it is used as a carrier of developer. Specifically, a ferrite carrier, a carrier obtained by coating the surfaces of magnetic particles as carrier core materials with a resin and the like can be cited as such. Specifically, magnetic metals such as iron, nickel and cobalt, alloys of these metals, alloys containing rare-earth elements, soft ferrites such as hematite, magnetite, manganese-zinc ferrite, nickel-zinc ferrite, manganese-magnesium ferrite and lithium ferrite, iron oxides such as copper-zinc ferrite, and magnetic particles produced by sintering and atomizing a magnetic material such as a mixture of these materials can be cited as the carrier core material.

Mixtures of binder resins such as silicone resin and acrylic resin and fluororesins such as polytetrafluoroethylene, polychlorotrifluoroethylene and polyvinylidene fluoride can be, for example, cited as a surface coating agent for coating the surfaces of the carrier core materials obtained as described above are.

The particle diameter of the carrier preferably is in a range of 20 to 200 μm, more preferably in a range of 30 to 150 μm, in general particle diameter by electron microscopy. The apparent density of the carrier differs depending on the composition, surface structure and the like of a magnetic body when the carrier mainly contains a magnetic material, but is generally preferably in a range of 3000 to 8000 kg/m³.

The toner density in the two-component developer containing the toner and carrier is 1 to 20 weight %, preferably 3 to 15 weight %. If the toner density is below 1 weight %, image density is too low. On the other hand, if the toner density exceeds 20 weight %, the toner may scatter in the developing device, thereby smearing the interior of the apparatus and causing undesired adhesion of the toner to transfer sheets and the like.

The developer of this embodiment is the two-component developer in which the toner and the carrier are mixed at a suitable ratio and can be used, for example, in the image forming apparatus to be described later.

[Image Forming Apparatus]

An image forming apparatus using the toner and the developer is not particularly limited provided that it is an electrophotographic image forming apparatus. Specifically, an image forming apparatus including an amorphous silicon photoconductor as a photoconductive drum is preferable in terms of durability as described above. Further, a tandem color image forming apparatus using a plurality of colors of toner is preferable. Here is described a tandem color image forming apparatus including amorphous silicon photoconductors as photoconductive drums. The image forming apparatus according to this embodiment is provided with a plurality of image bearing members arranged side by side in a specified direction for forming toner images with the toner of different colors on the surfaces thereof and a plurality of developing rollers arranged to face the corresponding image bearing members and adapted to convey the toner while bearing them on the surfaces thereof and to supply the conveyed toner to the surfaces of the corresponding image bearing members, wherein the image bearing members are respectively amorphous silicon photoconductors and each developer is the one according to this embodiment, i.e. developer containing toner for electrophotography according to this embodiment and a carrier.

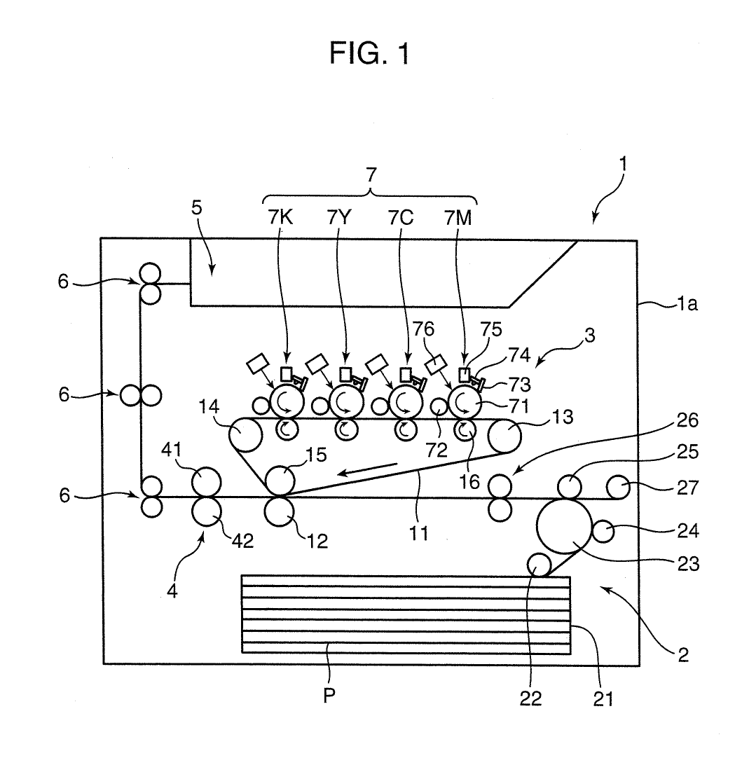

FIG. 1 is a schematic sectional view showing the entire construction of an image forming apparatus 1. Here, the image forming apparatus 1 is described, taking a color printer 1 as an example.

As shown in FIG. 1, the color printer 1 includes a box-shaped apparatus main body 1a. This apparatus main body 1a has a sheet feeder unit 2 for feeding sheets P, an image forming station 3 for transferring images to a sheet P fed from the sheet feeder unit 2 while conveying the sheet P, and a fixing unit 4 for fixing the images transferred to the sheet P in the image forming station 3. A sheet discharge unit 5, to which a sheet P finished with a fixing process in the fixing unit 4 is to be discharged, is provided on the upper surface of the apparatus main body 1a.

The sheet feeder unit 2 includes a sheet cassette 21, a pickup roller 22, feed rollers 23, 24 and 25, and a registration roller pair 26. The sheet cassette 21 is detachably mounted in the apparatus main body 1a for storing sheets P of respective sizes. The pickup roller 22 is disposed at a right-upper position of the sheet cassette 21 shown in FIG. 1 and dispenses the sheets P stored in the sheet cassette 21 one by one. The feed rollers 23, 24 and 25 feed a sheet P dispensed by the pickup roller 22 to a sheet conveyance path. The registration roller pair 26 supplies a sheet fed to the sheet conveyance path by the feed rollers 23, 24 and 25 to the image forming station 3 at a specified timing after causing the sheet P to temporarily wait on standby.

The sheet feeder unit 2 further includes an unillustrated manual feed tray mounted on the right surface of the apparatus main body 1a in FIG. 1 and a pickup roller 27. This pickup roller 27 dispenses a sheet P placed on the manual feed tray. The sheet P dispensed by the pickup roller 27 is fed to the sheet conveyance path by the feed rollers 23, 25 and supplied to the image forming station 3 at a specified timing by the registration roller pair 26.

The image forming station 3 includes image forming units 7, an intermediate transfer belt 11, to the outer surface of which toner images are primarily transferred by the image forming units 7, and a secondary transfer roller 12 for secondarily transferring the toner images on the intermediate transfer belt 11 to a sheet P fed from the sheet feeder unit 2.

The image forming units 7 include a black unit 7K, a yellow unit 7Y, a cyan unit 7C and a magenta unit 7M successively arranged from an upstream side (left side in FIG. 1) to a downstream side. In each of the respective units 7K, 7Y, 7C and 7M, a photoconductive drum 71 as an image bearing member is arranged rotatably in an arrow direction (counterclockwise direction) at a center position. A charger 75, an exposure device 76, a developing device 72, a cleaner 73 and a charge neutralizer 74 and the like are successively arranged around each photoconductive drum 71 from an upstream side in a rotating direction. An amorphous silicon photoconductor whose photoconductive layer contains amorphous silicon can be, for example, cited as the photoconductive drum 71.

The charger 75 is for uniformly charging the circumferential surface of the photoconductive drum 71 rotated in the arrow direction. A scorotron charger can be, for example, cited as the charger 75. The exposure device 76 is a so-called laser scanning unit and irradiates the circumferential surface of the photoconductive drum 71 uniformly charged by the charger 75 with a laser beam based on image data input from an image reader or the like to form an electrostatic latent image based on image data on the photoconductive drum 71. The developing device 72 forms a toner image based on the image data by supplying the toner to the circumferential surface of the photoconductive drum 71 formed with the electrostatic latent image. This toner image is primarily transferred to the intermediate transfer belt 11. The cleaner 73 cleans the toner residual on the circumferential surface of the photoconductive drum 71 after the primary transfer of the toner image to the intermediate transfer belt 11 is finished. The charge neutralizer 74 electrically neutralizes the circumferential surface of the photoconductive drum 71 after the primary transfer is finished. The circumferential surface of the photoconductive drum 71 cleaned by the cleaner 73 and the charge neutralizer 74 heads for the charger 75 for a new charging process, thereby preparing for new image formation.

The intermediate transfer belt 11 is an endless belt-like rotary member and is so mounted on a plurality of rollers such as a drive roller 13, a belt supporting roller 14, a backup roller 15 and primary transfer rollers 16 that the outer surface (contact surface) thereof is held in contact with the circumferential surfaces of the respective photoconductive drums 71. The intermediate transfer belt 11 is endlessly rotated by the plurality of rollers while being pressed against the photoconductive drums 71 by the primary transfer rollers 16 arranged to face the corresponding photoconductive drums 71.

The drive roller 13 is driven and rotated by a drive source such as a stepping motor and gives a drive force for endlessly rotating the intermediate transfer belt 11. The belt supporting roller 14 and the backup roller 15 are driven rollers which are rotatably disposed and rotated as the intermediate transfer belt 11 is endlessly rotated by the drive roller 13. These driven rollers 14, 15 are driven and rotated via the intermediate transfer belt 11 by the rotation of the drive roller 13 and support the intermediate transfer belt 11.

Each primary transfer roller 16 applies a primary transfer bias (having a polarity opposite to the electrification polarity of the toner) to the intermediate transfer belt 11. By doing so, toner images formed on the respective photoconductive drums 71 are successively transferred (primary transfer) in a superimposition manner to the intermediate transfer belt 11 rotating in an arrow direction (clockwise direction) by the driving of the drive roller 13 between the respective photoconductive drums 71 and the primary transfer rollers 16. The primary transfer rollers 16 rotate by obtaining drive forces from drive motors for rotating the photoconductive drums 71.

The secondary transfer roller 12 applies a secondary transfer bias having a polarity opposite to that of the toner images primarily transferred to the intermediate transfer belt 11. By doing so, the primarily transferred toner images on the intermediate transfer belt 11 are transferred to a sheet P between the secondary transfer roller 12 and the backup roller 15, whereby a full color toner image is formed on the sheet P.

The fixing unit 4 is for fixing the toner image transferred to the sheet P in the image forming station 3 and includes a heating roller 41 to be heated by an electrical heating element and a pressure roller 42 which is arranged to face the heating roller 41 and whose circumferential surface is pressed into contact with the circumferential surface of the heating roller 41.

The toner image transferred to the sheet P by the secondary transfer roller 12 in the image forming station 3 is fixed to the sheet P by a fixing process through heating and pressing when the sheet P passes between the heating roller 41 and the pressure roller 42. The sheet P finished with the fixing process is discharged to the sheet discharge unit 5. In the color printer 1, conveyor roller pairs 6 are disposed at suitable positions between the fixing unit 4 and the sheet discharge unit 5.

The image forming apparatus 1 forms an image on a sheet P by the image forming operation as described above. In the above tandem image forming apparatus, by using the above developer, the occurrence of fogging can be suppressed and, hence, high-quality images can be formed for a long period of time even if high-density images are printed after low-density printing was performed for a long time.

### EXAMPLES

The present invention is further specifically described below by way of examples. The present invention is not limited at all by these examples.

(Method for Producing Surface Treated Particles “a”)

100 parts by mass of ion exchange water and 1 part by mass of ethylene glycol monostearate (surfactant) were poured into a 2-liter separable flask equipped with an agitator, a thermometer, a nitrogen introduction pipe, a reflux condenser and a drip funnel and heated until liquid temperature reached 80° while being agitated under a nitrogen stream. Thereafter, 0.1 part of polymerization initiator (2,2′-azobis(2-methylpropion amidine) bihydrochloride) was added, 70 parts by mass of methyl methacrylate and 30 parts by mass of butyl methacrylate were dripped and the resultant liquid was kept at 80° C. for 3 hours. The obtained liquid is purified by an ultrafilter and spray dried to obtain powder (methacrylate resin fine particles).

1 part by mass of the obtained methacrylate resin fine particles and 0.01 part by mass of zinc stearate (zinc stearate S-Z produced by NOF Corporation) as a surface treating agent were poured into a Henschel mixer and mixed. By doing so, surface treated particles “a” were obtained.

### (Method for Measuring the Charged Amount of the Surface Treated Particles)

The charged amounts of the obtained surface treated particles “a” were measured as follows. First of all, 1 part by mass of the obtained surface treated particles “a” and 100 parts by mass of ferrite carrier (F-300 produced by Powder Tech Corporation) having an average particle diameter of 40 μm were poured into a Turbula® shaker mixer and mixed for a specified time. Then, the charged amount of the obtained mixture was measured using a suction-type charge measuring apparatus (q/m meter MODEL 210HS produced by Trek Inc.).

As a result, the charged amount of the surface treated particles “a” after mixing for 5 minutes was −40 μC/g and that after mixing for 30 minutes was 20 μC/g and that after mixing for 120 minutes was 20 μC/g.

(Surface Treated Particles “b”)

Surface treated particles “b” were obtained by the same production method of the above surface treated particles “a” except that magnesium stearate (SM-1000 produced by Sakai Chemical Industry Co., Ltd.) was used instead of zinc stearate.

The charged amounts of the obtained surface treated particles “b” were as follows as a result of a measurement by the above method for measuring the charged amount of the surface treated particles. The charged amount of the surface treated particles “b” after mixing for 5 minutes was −35 μC/g, that after mixing for 30 minutes was 25 μC/g and that after mixing for 120 minutes was 25 μC/g.

(Surface Treated Particles “c”)

Surface treated particles “c” were obtained by the same production method of the above surface treated particles “a” except that zinc laurate (Z-12F produced by Sakai Chemical Industry Co., Ltd.) was used instead of zinc stearate.

The charged amounts of the obtained surface treated particles “c” were as follows as a result of a measurement by the above method for measuring the charged amount of the surface treated particles. The charged amount of the surface treated particles “c” after mixing for 5 minutes was −45 μC/g, that after mixing for 30 minutes was 15 μC/g and that after mixing for 120 minutes was 15 μC/g.

(Surface Treated Particles “d”)

Surface treated particles “d” were obtained by the same production method of the above surface treated particles “a” except that acrylic resin fine particles were used instead of methacrylic resin fine particles.

The charged amounts of the obtained surface treated particles “d” were as follows as a result of a measurement by the above method for measuring the charged amount of the surface treated particles. The charged amount of the surface treated particles “d” after mixing for 5 minutes was −40 μC/g, that after mixing for 30 minutes was 18 μC/g and that after mixing for 120 minutes was 18 μC/g.

The acrylic resin fine particles were obtained as follows.

1100 parts by weight of ion exchange water, 0.4 parts of weight of polyvinyl alcohol and 300 parts by weight of methyl acrylate were prepared in a 2-liter separable flask equipped with an agitator, a thermometer, a nitrogen introduction pipe, a reflux condenser and a drip funnel and heated until liquid temperature reached 80° while being agitated under a nitrogen stream. As a polymerization initiator, 1.0 part by weight of potassium persulfate and 1.1 parts by weight of sodium thiosulfate were poured to start polymerization. Thereafter, 3 parts by weight of acrylic acid and 100 parts by weight of ion exchange water were dripped for 10 minutes and, thereafter, the mixture was allowed to react for 3 hours with reaction temperature held at 70° C. 1.0 part by weight of magnesium acetate was added to the obtained latex, which was then dried using a spray drier and crushed by a jet mill to obtain acrylic resin fine particles.

(Surface Treated Particles “e”)

Surface treated particles “e” were obtained by the same production method of the above surface treated particles “a” except that fluorosilicone oil (FS1265 produced by Toray-Dow Corning) was mixed with methacrylic resin fine particles instead of zinc stearate.

The charged amounts of the obtained surface treated particles “e” were as follows as a result of a measurement by the above method for measuring the charged amount of the surface treated particles. The charged amount of the surface treated particles, “e” after mixing for 5 minutes was −40 μC/g, that after mixing for 30 minutes was −35 μC/g and that after mixing for 120 minutes was −35 μC/g.

(Surface Treated Particles “f”)

Surface treated particles “f” were obtained by the same production method of the above surface treated particles “a” except that amino modified silicone (KF-8004 produced by Shin-Etsu Chemical Co., Ltd.) instead of zinc stearate.

The charged amounts of the obtained surface treated particles “f” were as follows as a result of a measurement by the above method for measuring the charged amount of the surface treated particles. The charged amount of the surface treated particles “f” after mixing for 5 minutes was 20 μC/g, that after mixing for 30 minutes was 5 μC/g and that after mixing for 120 minutes was 5 μC/g.

(Surface Treated Particles “g”)

Surface treated particles “g” were obtained by the same production method of the above surface treated particles “a” except that fluororesin fine particles (Rublon L-2 produced by Daikin Industries Ltd.) were used instead of methacrylic resin fine particles and an aminosilane type silane coupling agent (A0774 produced by Tokyo Chemical Industry Co., Ltd.) was mixed instead of zinc stearate.

The charged amounts of the obtained surface treated particles “g” were as follows as a result of a measurement by the above method for measuring the charged amount of the surface treated particles. The charged amount of the surface treated particles “g” after mixing for 5 minutes was 10 μC/g, that after mixing for 30 minutes was −10 μC/g and that after mixing for 120 minutes was −10 μC/g.

(Surface Treated Particles “h”)

Surface treated particles “h” were obtained by the same production method of the above surface treated particles “a” except that 0.0005 parts by mass of zinc stearate (zinc stearate S-Z produced by NOF Corporation) instead of 0.01 part by mass of zinc stearate.

The charged amounts of the obtained surface treated particles “h” were as follows as a result of a measurement by the above method for measuring the charged amount of the surface treated particles. The charged amount of the surface treated particles “h” after mixing for 5 minutes was −10 μC/g, that after mixing for 30 minutes was 20 μC/g and that after mixing for 120 minutes was 20 μC/g.

(Surface Treated Particles “i”)

Surface treated particles “i” were obtained by the same production method of the above surface treated particles “a” except that 0.001 part by mass of zinc stearate (zinc stearate S-Z produced by NOF Corporation) instead of 0.01 part by mass of zinc stearate.

The charged amounts of the obtained surface treated particles “i” were as follows as a result of a measurement by the above method for measuring the charged amount of the surface treated particles. The charged amount of the surface treated particles “i” after mixing for 5 minutes was −25 μC/g, that after mixing for 30 minutes was 15 μC/g and that after mixing for 120 minutes was 20 μC/g.

(Surface Treated Particles “j”)

Surface treated particles “j” were obtained by the same production method of the above surface treated particles “a” except that 0.1 part by mass of zinc stearate (zinc stearate S-Z produced by NOF Corporation) instead of 0.01 part by mass of zinc stearate.

The charged amounts of the obtained surface treated particles “j” were as follows as a result of a measurement by the above method for measuring the charged amount of the surface treated particles. The charged amount of the surface treated particles “j” after mixing for 5 minutes was −50 μC/g, that after mixing for 30 minutes was 10 μC/g and that after mixing for 120 minutes was 20 μC/g.

(Surface Treated Particles “k”)

Surface treated particles “k” were obtained by the same production method of the above surface treated particles “a” except that 0.2 parts by mass of zinc stearate (zinc stearate S-Z produced by NOF Corporation) instead of 0.01 part by mass of zinc stearate.

The charged amounts of the obtained surface treated particles “k” were as follows as a result of a measurement by the above method for measuring the charged amount of the surface treated particles. The charged amount of the surface treated particles “k” after mixing for 5 minutes was −60 μC/g, that after mixing for 30 minutes was 5 μC/g and that after mixing for 120 minutes was 20 μC/g.

The above respective particulars of the surface treated particles “a” to “k” are summarized in TABLE-1.

TABLE 1

| Surface | | | Added Amount (Part by Mass) of | Charged Amount (μC/g) of | | |
|---|---|---|---|---|---|---|
| Treated | Resin Fine | Surface | Surface Treating Agent in 1 | Surface Treated Particles | | |
| Particles | Particles | Treatment | Mass Part of Rein Fine Particles | After 5 min | After 30 min | After 120 min |
| “a” | Methacrylic | Zinc Stearate | 0.01 | −40 | 20 | 20 |
| “b” | | Magnesium Stearate | | −35 | 25 | 25 |
| “c” | | Zinc Laurate | | −45 | 15 | 15 |
| “d” | Acrylic | Zinc Stearate | | −40 | 18 | 18 |
| “e” | Methacrylic | Fluorination | 0.01 | −40 | −35 | −35 |
| “f” | | Amino Modified | | 20 | 5 | 5 |
| | | Silicone Oil | | | | |
| “g” | Fluoro | Aminosilane | | 10 | −10 | −10 |
| “h” | Methacrylic | Zinc Stearate | 0.0005 | −10 | 20 | 20 |
| “i” | | Zinc Stearate | 0.001 | −25 | 15 | 20 |
| “j” | | Zinc Stearate | 0.1 | −50 | 10 | 20 |
| “k” | | Zinc Stearate | 0.2 | −60 | 5 | 20 |

As can be understood from TABLE-1, unlike the surface treated particles (surface treated particles “e” to “g”) obtained by surface treating the resin fine particles with the surface treating agents other than the fatty acid metal salts, the charged amounts of the surface treated particles (surface treated particles “a” to “d” and “h” to “k”) obtained by surface treating the resin fine particles with the fatty acid metal salts transition from negative to positive depending on the mixed time with the ferrite carrier. It can be understood from this that the electrification property of the surface treated particles (surface treated particles “a” to “d” and “h” to “k”) obtained by surface treating the resin fine particles with the fatty acid metal salts to gradually make the charged amount transition from negative to positive can achieve an effect of neutralizing the electrification property of the toner base particles containing no surface treated particles to be gradually negatively charged.

A change in the charged amount is larger in the case where the added amount of the fatty acid metal salt is 0.001 to 0.1 part by mass per 1 part by mass of the resin fine particles (surface treated particles “a” to “d”, “i” and “j”) as compared with the case where the added amount is below 0.001 part by mass (surface treated particles “h”). It can be understood from this that the effect of neutralizing the electrification property of the toner base particles containing no surface treated particles to be gradually negatively charged can be achieved better in the case where the added amount of the fatty acid metal salt is 0.001 to 0.1 part by mass per 1 part by mass of the resin fine particles (surface treated particles “a” to “d”, “i” and “j”). If the added amount of the fatty acid metal salt exceeds 0.1 part by mass per 1 part by mass of the resin fine particles (surface treated particles “k”), the initial charged amount of the surface treated particles is too large at the negative (minus) side, wherefore the initial charged amount of the toner may possibly be lower than a specified value.

### Example 1

### Production of Black Toner

First of all, 100 parts by mass of polyester resin (Tafton NE-1110 produced by Kao Corporation) obtained by polycondensation of bisphenol A and fumaric acid as a binder resin, 4 parts by mass of carbon black (MA-100 produced by Mitsubishi Chemical Corporation) as a colorant, 3 parts by mass of Fischer-Tropsch wax (FT-100 produced by Nippon Seiro Co., Ltd.) as a wax and 2 parts by weight of quaternary ammonium salt compound (P-51 produced by Orient Chemical Industries Co., Ltd.) as a charge-controlling agent were mixed for 2 minutes in a Henschel mixer (produced by Nippon Coke & Engineering Co., Ltd.). Thereafter, the obtained mixture was melted and kneaded by a two-screw extruder (PCM-30 produced by Ikegai). The obtained melted and kneaded material was pulverized by an air flow crusher (jet mill IDS-2 produced by Nippon Pneumatic Mfg. Co., Ltd.) and classified by a wind power classifier (TPS classifier produced by Hosokawa Micron Corporation). By doing so, toner base particles having a volume average diameter of 8 μm were obtained. Note that the volume average diameter of the toner base particles was measured by a particle size analyzer (Multisizer 3 produced by Beckman Coulter).

Subsequently, 1 part by mass of silica particles (TG-820 produced by Cabot), 1.5 parts by mass of titanium oxide particles (JR-405 produced by Tayca Corporation) and 0.1 part by mass of the surface treated particles “a” were added as external additives to 100 parts by mass of the obtained toner base particles and mixed at 3000 rpm for 10 minutes in the above Henschel mixer. By doing so, toner (toner base particles having the external additives externally added) was obtained. The content of the surface treated particles “a” per 100 parts by mass of the toner base particles is 0.1 part by mass, and the content of the surface treated particles “a” per 100 parts by mass of the total external additives is about 3.85 parts by mass.

### (Production of Yellow Toner)

Yellow toner was produced in the same manner as the above black toner except that 2 parts by mass of yellow pigment (C. I. pigment yellow 180) was added instead of 4 parts by mass of carbon black.

### (Production of Cyan Toner)

Cyan toner was produced in the same manner as the above black toner except that 3 parts by mass of cyan pigment (C. I. pigment blue 15-3) was added instead of 4 parts by mass of carbon black.

### (Production of Magenta Toner)

Magenta toner was produced in the same manner as the above black toner except that 3 parts by mass of magenta pigment (C. I. pigment red 238) was added instead of 4 parts by mass of carbon black.

### (Production of Developer)

10 parts by mass of each toner obtained as described above was so mixed with 100 parts by mass of ferrite carrier to have a ratio (toner density) of 10, thereby obtaining developer.

### Example 2

Toner and developer were produced in the same manner as in Example 1 except that the surface treated particles “b” were used instead of the surface treated particles “a”.

### Example 3

Toner and developer were produced in the same manner as in Example 1 except that the surface treated particles “c” were used instead of the surface treated particles “a”.

### Example 4

Toner and developer were produced in the same manner as in Example 1 except that the surface treated particles “d” were used instead of the surface treated particles “a”.

### Example 5

Toner and developer were produced in the same manner as in Example 1 except that the surface treated particles “h” were used instead of the surface treated particles “a”.

### Example 6

Toner and developer were produced in the same manner as in Example 1 except that the surface treated particles “i” were used instead of the surface treated particles “a”.

### Example 7

Toner and developer were produced in the same manner as in Example 1 except that the surface treated particles “j” were used instead of the surface treated particles “a”.

### Example 8

Toner and developer were produced in the same manner as in Example 1 except that the surface treated particles “k” were used instead of the surface treated particles “a”.

### Example 9

Toner and developer were produced in the same manner as in Example 1 except that 0.005 parts by mass of the surface treated particles “a” were added to 100 parts by mass of the toner base particles. Note that the content of the surface treated particles “a” per 100 parts by mass of the toner base particles is 0.005 parts by mass and that of the surface treated particles “a” per 100 parts by mass of the total external additives is about 0.2 parts by mass.

### Example 10

Toner and developer were produced in the same manner as in Example 1 except that 0.01 parts by mass of the surface treated particles “a” were added to 100 parts by mass of the toner base particles. Note that the content of the surface treated particles “a” per 100 parts by mass of the toner base particles is 0.01 parts by mass and that of the surface treated particles “a” per 100 parts by mass of the total external additives is about 0.4 parts by mass.

### Example 11

Toner and developer were produced in the same manner as in Example 1 except that 1 part by mass of the surface treated particles “a” were added to 100 parts by mass of the toner base particles. Note that the content of the surface treated particles “a” per 100 parts by mass of the toner base particles is 1 part by mass and that of the surface treated particles “a” per 100 parts by mass of the total external additives is about 28.57 parts by mass.

### Example 12

Toner and developer were produced in the same manner as in Example 1 except that 1.2 parts by mass of the surface treated particles “a” were added to 100 parts by mass of the toner base particles. Note that the content of the surface treated particles “a” per 100 parts by mass of the toner base particles is 1.2 parts by mass and that of the surface treated particles “a” per 100 parts by mass of the total external additives is about 32.43 parts by mass.

### Example 13

Toner and developer were produced in the same manner as in Example 1 except that 3.5 parts by mass of silica particles (TG-820 produced by Cabot), 1 part by mass of titanium oxide particles (JR-405 produced by Tayca Corporation) and 0.01 part by mass of the surface treated particles “a” were added as external additives to 100 parts by mass of the toner base particles. Note that the content of the surface treated particles “a” per 100 parts by mass of the toner base particles is 0.01 part by mass and that of the surface treated particles “a” per 100 parts by mass of the total external additives is about 0.22 parts by mass.

### Example 14

Toner and developer were produced in the same manner as in Example 1 except that 3 parts by mass of silica particles (TG-820 produced by Cabot), 1 part by mass of titanium oxide particles (JR-405 produced by Tayca Corporation) and 0.01 part by mass of the surface treated particles “a” were added as external additives to 100 parts by mass of the toner base particles. Note that the content of the surface treated particles “a” per 100 parts by mass of the toner base particles is 0.01 part by mass and that of the surface treated particles “a” per 100 parts by mass of the total external additives is about 0.25 parts by mass.

### Example 15

Toner and developer were produced in the same manner as in Example 1 except that 1.4 parts by mass of silica particles (TG-820 produced by Cabot), 1 part by mass of titanium oxide particles (JR-405 produced by Tayca Corporation) and 1 part by mass of the surface treated particles “a” were added as external additives to 100 parts by mass of the toner base particles. Note that the content of the surface treated particles “a” per 100 parts by mass of the toner base particles is 1 part by mass and that of the surface treated particles “a” per 100 parts by mass of the total external additives is about 29.41 parts by mass.

### Example 16

Toner and developer were produced in the same manner as in Example 1 except that 1 part by mass of silica particles (TG-820 produced by Cabot), 1 part by mass of titanium oxide particles (JR-405 produced by Tayca Corporation) and 1 part by mass of the surface treated particles “a” were added as external additives to 100 parts by mass of the toner base particles. Note that the content of the surface treated particles “a” per 100 parts by mass of the toner base particles is 1 part by mass and that of the total external additives “a” per 100 parts by mass of the total external additives is about 33.33 parts by mass.

### Comparative Example 1

Toner and developer were produced in the same manner as in Example 1 except that the surface treated particles “e” were used instead of the surface treated particles “a”.

### Comparative Example 2

Toner and developer were produced in the same manner as in Example 1 except that the surface treated particles “f” were used instead of the surface treated particles “a”.

### Comparative Example 3

Toner and developer were produced in the same manner as in Example 1 except that the surface treated particles “g” were used instead of the surface treated particles “a”.

### [Evaluations]

The obtained Toner and developer were evaluated by the following method.

First of all, using a color MFP (KM-C3232) produced by Kyocera Mita Corp. as an evaluator, the obtained respective developer as start developer and the obtained respective Toner as replenishment Toner were used, images were formed under a normal temperature and normal humidity environment having a temperature of 20 to 23° C. and a relative humidity of 50 to 65% RH and the following evaluations were conducted.

Specifically, the start developer was set in the evaluator and the evaluator was stabilized after the evaluator has been turned on. Thereafter, an image for evaluation was output. The image obtained by this output was set as an initial image.

Subsequently, while the replenishment toner was supplied as necessary, 2000 images with a coverage rate of 0.1% were printed. After printing 2000 images, an image for evaluation was output. The image obtained by this output was set as a low-density printed image.

Thereafter, while the replenishment toner was supplied as necessary, 1000 images with a coverage rate of 30% were printed. After printing 1000 images, an image for evaluation was output. The image obtained by this output was set as a high-density printed image.

The images for evaluation were output every 500 prints at the time of printing 2000 images having the coverage rate of 0.1% and at the time of printing 1000 images having the coverage rate of 30%.

### (Image Density)

In each of the initial image, the low-density printed image and the high-density printed image, solid images of 2×2 cm are formed at three positions, i.e. a position near the left end, a central position and a position near the right end in a sheet width direction.

The reflecting densities of the respective solid images of each formed image were measured using a reflection densitometer (RD-19A: SpectroEyeLT produced by Gretag Macbeth). An average value was set as the image density of the obtained image. The image densities were measured for every 500^{th} image from the initial image.

“◯” was evaluated if the lower limit value of the measured image densities was equal to or above 1.2, “Δ” was evaluated if it was equal to or above 1, but below 1.2 and “x” was evaluated if it was below 1.

### (Fogging)

A value obtained by subtracting the value of the image density of base paper (i.e. blank before the image output) from the value of the image density of a blank equivalent part of each obtained image measured by the above mentioned reflection densitometer was set as a fogging density. The fogging density was measured for every 500^{th} image from the initial image.

“⊚” was evaluated if the maximum value of the fogging densities was equal to or below 0.007, “◯” was evaluated if it is above 0.007, but equal to or equal to or below 0.010, “Δ” was evaluated if it was above 0.010, but equal to or below 0.020 and “x” was evaluated if it was above 0.020.

### (Charged Amount)

The developer immediately after the initial image, the low-density printed image and the high-density printed image were printed were taken out and the respective charged amounts were measured in the same manner as above.

The respective evaluation results are shown in TABLE-2.

TABLE 2

| | | | | | Charged Amount (μC/g) | | | | | | | |
|---|---|---|---|---|---|---|---|---|---|---|---|---|
| | | | | | Cov. | | | | | | | |
| | Surface | | | | Rate | | | | | | | |
| | Treated | | | | of 0.1% | | Cov. Rate of 30% | Image Density | | | Fogging | |
| | Particles | A | B | C | D | E | F | Ini. Image | Min V. | Eval. | Max V. | Eval |
| EX. 1 | “a” | 0.1 | 3.85 | 2.5 | 15 | 24 | 12 | 1.41 | 1.33 | ◯ | 0.000 | ⊚ |
| EX. 2 | “b” | 0.1 | 3.85 | 2.5 | 18 | 27 | 15 | 1.27 | 1.29 | ◯ | 0.000 | ⊚ |
| EX. 3 | “c” | 0.1 | 3.85 | 2.5 | 13 | 22 | 11 | 1.57 | 1.4 | ◯ | 0.000 | ⊚ |
| EX. 4 | “d” | 0.1 | 3.85 | 2.5 | 15 | 24 | 12 | 1.45 | 1.35 | ◯ | 0.000 | ⊚ |
| EX. 5 | “h” | 0.1 | 3.85 | 2.5 | 20 | 32 | 15 | 1.15 | 1.15 | Δ | 0.010 | ◯ |
| EX. 6 | “l” | 0.1 | 3.85 | 2.5 | 18 | 28 | 18 | 1.28 | 1.22 | ◯ | 0.000 | ⊚ |
| EX. 7 | “j” | 0.1 | 3.85 | 2.5 | 15 | 26 | 15 | 1.45 | 1.24 | ◯ | 0.000 | ⊚ |
| EX. 8 | “k” | 0.1 | 3.85 | 2.5 | 8 | 20 | 11 | 1.57 | 1.37 | ◯ | 0.010 | ◯ |
| EX. 9 | “a” | 0.005 | 0.20 | 2.5 | 18 | 36 | 6 | 1.27 | 1.2 | ◯ | 0.013 | Δ |
| EX. 10 | | 0.01 | 0.40 | 2.5 | 19 | 29 | 19 | 1.21 | 1.22 | ◯ | 0.000 | ⊚ |
| EX. 11 | | 1 | 28.57 | 2.5 | 20 | 33 | 26 | 1.22 | 1.24 | ◯ | 0.000 | ⊚ |
| EX. 12 | | 1.2 | 32.43 | 2.5 | 20 | 35 | 30 | 1.15 | 1.16 | Δ | 0.000 | ⊚ |
| EX. 13 | | 0.01 | 0.22 | 4.5 | 18 | 15 | 5 | 1.26 | 1.43 | ◯ | 0.012 | Δ |
| EX. 14 | | 0.01 | 0.25 | 4.0 | 19 | 14 | 13 | 1.21 | 1.4 | ◯ | 0.000 | ⊚ |
| EX. 15 | | 1 | 29.41 | 2.4 | 21 | 34 | 30 | 1.2 | 1.22 | ◯ | 0.000 | ⊚ |
| EX. 16 | | 1 | 33.33 | 2.0 | 22 | 44 | 35 | 1.12 | 1.03 | Δ | 0.000 | ⊚ |
| CEX. 1 | “e” | 0.1 | 3.85 | 2.5 | 15 | 10 | 2 | 1.46 | 1.6 | ◯ | 0.050 | X |
| CEX. 2 | “f” | 0.1 | 3.85 | 2.5 | 35 | 40 | 28 | 1.09 | 1.11 | Δ | 0.021 | X |
| CEX. 3 | “g” | 0.1 | 3.85 | 2.5 | 25 | 20 | 5 | 1.15 | 1.3 | ◯ | 0.030 | X |

A: Content (part by mass) of surface treated particles per 100 parts by mass of toner base particles
B: Content (part by mass) of surface treated particles per 100 parts by mass of total external additives
C: Content (mass part) of inorganic fine particles per 100 parts by mass of toner base particles
D: Initial image (0 print),
E: Low-density printed image (2000 prints),
F: High-density printed image (3000 prints)

As can be understood from TABLE-2, the fogging density was lower even if the image density is about equal in the case of containing the surface treated particles obtained by surface treating the resin fine particles with the fatty acid metal salt as the external additive (Examples 1 to 16) than in the case of containing the surface treated particles obtained by surface treating the resin fine particles with the surface treating agent other than the fatty acid metal salt (Comparative Examples 1 to 3). This is thought to be because of a small change in the charged amount.

The fogging density was even lower in the case where the added amount of the fatty acid metal salt was 0.001 to 0.1 part by mass per 1 part by mass of the resin fine particles (Examples 1 to 4, 6 and 7) than in the case where the added amount is below 0.001 part by mass (Example 5) or above 0.1 part by mass (Example 8). This is thought to be because the change in the charged amount of the toner is smaller and the charged amount of the toner is kept in a proper range.

The fogging density was even lower in the case where the content of the surface treated particles per 100 parts by mass of the toner base particle was 0.01 to 1 part by mass (e.g. Examples 10 and 11) than in the case where the content was below 0.01 part by mass (Example 9). The image density was higher with the fogging density kept at a low level in the case where the content of the surface treated particles per 100 parts by mass of the toner base particle was 0.01 to 1 part by mass (e.g. Examples 10 and 11) than in the case where the content was above 1 part by mass (Example 12). This is also thought to be because the change in the charged amount of the toner is smaller and the charged amount of the toner is kept in a proper range.

The fogging density was even lower in the case where the content of the surface treated particles per 100 parts by mass of the external additives was 0.25 to 30 parts by mass (e.g. Examples 14 and 15) than in the case where the content was below 0.25 parts by mass (Example 13). The image density was higher with the fogging density kept at a low level in the case where the content of the surface treated particles per 100 parts by mass of the external additives was 0.25 to 30 parts by mass (e.g. Examples 14 and 15) than in the case where the content was above 30 parts by mass (Example 16). This is also thought to be because the change in the charged amount of the toner is smaller and the charged amount of the toner is kept in a proper range.

Various technologies have been disclosed in this specification as described above. Main technologies of these are summarized as follows.

One aspect of the present invention relates to a toner for electrophotography comprising toner base particles containing a binder resin and a colorant, and an external additive to be externally added to the toner base particles, wherein the external additive contains surface treated particles obtained by surface treating resin fine particles with a fatty acid metal salt.

According to this composition, the occurrence of fogging can be suppressed and, hence, high-quality images can be formed for a long period of time even if printing is performed with a largely varying coverage rate for a long time.

This is thought to be because the toner having the above composition is a toner, the charged amount of which changes a little even if low-density printing with a low coverage rate is performed for a long time.

Resin fine particles such as acrylic resin fine particles and methacrylic resin fine particles are positively charged. The surface treated particles obtained by surface treating the resin fine particles with a fatty acid metal salt are negatively charged. The reason why the surface treated particles are negatively charged is thought to be that the surfaces of the resin fine particles are coated with the fatty acid metal salt. Thus, such surface treated particles are negatively charged in an initial state, but the fatty acid metal salt gradually separates from the surface treated particles and the surface treated particles come to be positively charged as the developer is mixed and agitated to be stressed such as when low-density printing is performed. Therefore, the surface treated particles are thought to contribute to the toner being gradually positively charged as low-density printing is performed.

On the other hand, the respective components of the toner base particles other than the surface treated particles, particularly most of the external additive other than the surface treated particles are thought to be gradually negatively charged as the developer is mixed and agitated. Therefore, the toner base particles containing no surface treated particles is thought to be gradually negatively charged as low-density printing is performed.

Accordingly, a change in the charged amount of the toner containing the surface treated particles is thought to be buffered as described above even if low-density printing is performed. Therefore, the toner having the above composition is thought to have a little change in the charged amount even if low-density printing with a low coverage rate is performed for a long time.

Since the above toner has a little change in the charged amount, it can suppress the occurrence of fogging and, hence, can form high-quality images for a long period of time.

This application is based on Japanese Patent Application Serial No. 2009-178105, filed in Japan Patent Office on Jul. 30, 2009, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. Toner for electrophotography, comprising:
toner base particles containing a binder resin and a colorant; and
an external additive to be externally added to the toner base particles,
wherein the external additive contains surface treated particles obtained by surface treating resin fine particles with a fatty acid metal salt.

2. Toner according to claim 1, wherein 0.01 to 1 part by mass of the surface treated particles are contained per 100 parts by mass of the toner base particles.

3. Toner according to claim 1, wherein:
the external additive further contains inorganic fine particles, and
0.25 to 30 parts by mass of the surface treated particles are contained per 100 parts by mass of the external additive.

4. Toner according to claim 1, wherein the surface treated particles are obtained by adding 0.001 to 0.1 part by mass of the fatty acid metal salt to 1 part by mass of the resin fine particles.

5. Toner according to claim 1, wherein the fatty acid metal salt is a metal salt of a saturated fatty acid having a carbon number of 12 to 24.

6. Toner according to claim 1, wherein the fatty acid metal salt is a metal salt of at least either one of a stearic acid and a lauric acid.

7. Toner according to claim 1, wherein the resin fine particles are at least either acrylic resin fine particles or methacrylic resin fine particles.

8. Developer, comprising:
toner for electrophotography according to claim 1; and
a carrier.

9. An image forming apparatus,
a plurality of image bearing members arranged side by side in a specified direction for forming toner images with toner of different colors on the respective surfaces thereof; and
a plurality of developing rollers arranged to face the corresponding image bearing members and adapted to convey the toner of developer while bearing them on the surfaces thereof and supply the conveyed toner to the surfaces of the corresponding image bearing members;
wherein:
the respective image bearing members are amorphous silicon photoconductors, and each developer is the one according to claim 8.
